(19) United States
(12) Patent Application Publication
(10) Pub. No.: US 2005/0078068 A1
(43) Pub. Date: Apr. 14, 2005

(54) Computer LCD monitor

(76) Inventor: Chig-Chieh Lin, Shu Lin City (TW)

Correspondence Address: LIN, Chig-Chieh, PO Box 82-144, Taipei, TW

(21) Appl. No.: 10/895,321

(22) Filed: Jul. 21, 2004

(30) Foreign Application Priority Data
Oct. 14, 2003 (TW) 092218254

(51) Int. Cl. G09G 5/00; G09G 3/34

(52) U.S. Cl. 345/86

(57) ABSTRACT

A computer LCD structure including a PC case, power supply, signal output cable, signal electronic board, and LCD board, characterized by having an additional electronic board showing data of V, A, W, PH, KWH, HZ, F, WA, PF, and KWH time signals provided with two signal output cables, one signal output cable being connected to the LCD board on the power supply and another connected to LCD board on the PC case panel for the user to facilitate reading the real time data of V, A, W, PH, KWH, HZ, F, WA, PF, and KWH.

### BACKGROUND OF THE INVENTION

(a) Technical Field of the Invention

The present invention is related to a computer LCD monitor structure, and more particularly, to one which also displays data including V, A, W, PH, KWH, HZ, F, WA, PF and KWH time.

(b) Description of the Prior Art

It takes a tester to find out V, A, W, PH, KWH, HZ, F, WA, PF and KWH time of a computer system in the prior art.

### SUMMARY OF THE INVENTION

The primary purpose of the present invention is to provide a computer LC monitor with an additional signal electronic board in power supply, an LCD board behind the power supply, a signal output cable in front of the power supply and an LCD board mounted to the PC case panel to facilitate the user reading all the data at a glance.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a preferred embodiment of the present invention.

FIG. 2 is a view showing the structure of the preferred embodiment of the present invention.

FIG. 3 is a schematic view showing the structure of the preferred embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

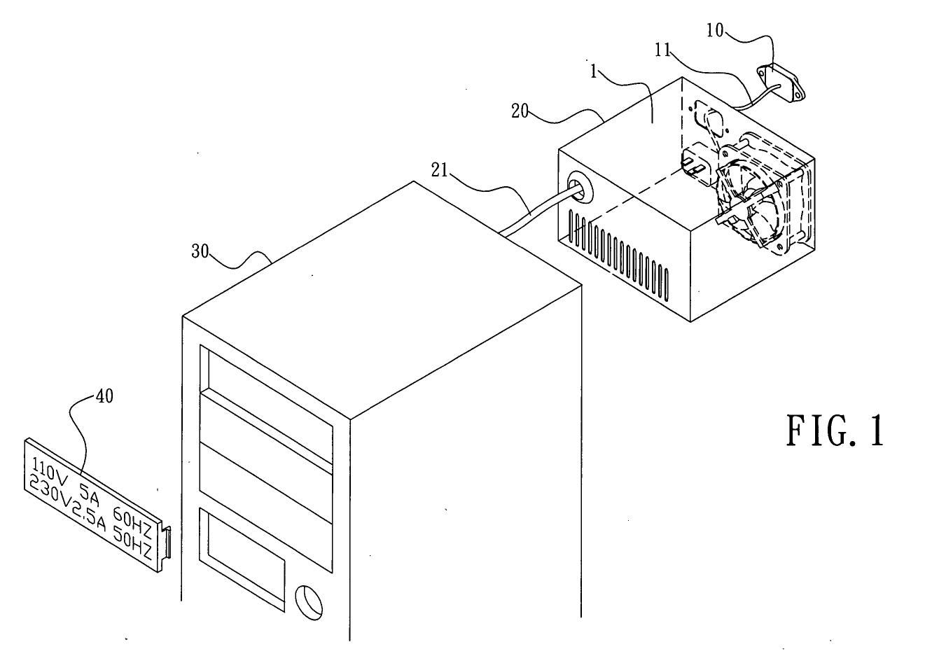

Referring to FIG. 1, an additional signal electronic board (01) is built in a power supply of a PC connected to a LCD board (10) via a signal output cable (11); and another end of the signal electronic board (01) is connected via another signal output cable (21) to an LCD board (40).

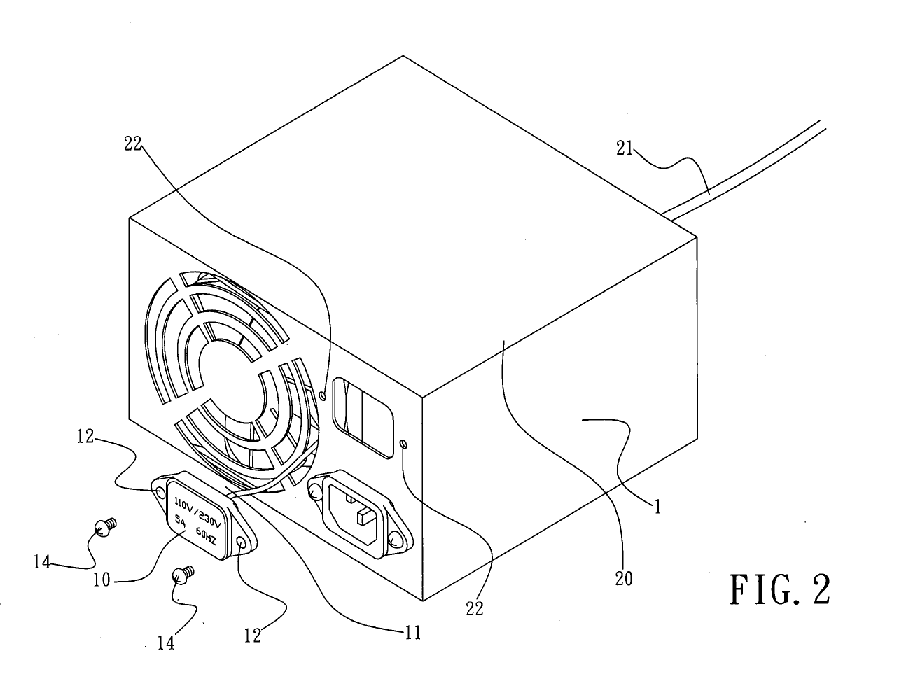

As illustrated in FIG. 2, the LCD board (10) is fitted with two screws (14) to corresponding threaded holes (22) disposed on a power supply (20) through a pair of holes (12) on the LCD (10).

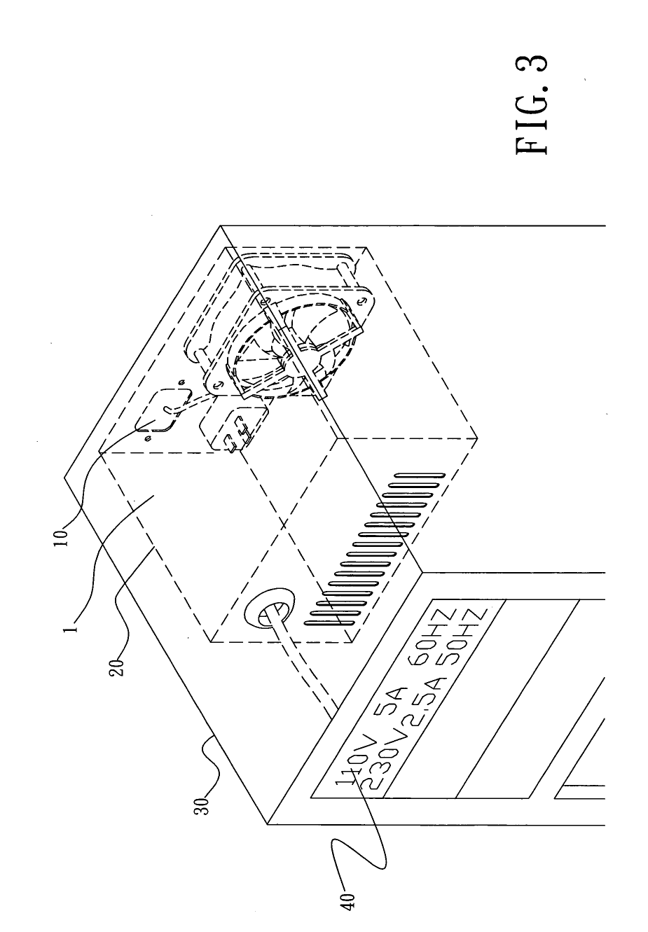

Now referring to FIG. 3, an LCD board (40) is inserted into the panel card of a PC case (30) to be connected to the signal electronic board built in the power supply (20) via the signal output cable (21), the power supply (20) is placed in the PC case (30), and the signal electronic board (01) built in the power supply is connected to the LCD board (10) via the signal output cable (11).

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A computer LCD structure essentially comprised of a PC case, power supply, signal output cable, signal electronic board, and LCD board, which is characterized by that an additional electronic board showing data of V, A, W, PH, KWH, HZ, F, WA, PF, and KWH time signals provided with two signal output cables, one signal output cable being connected to the LCD board on the power supply and another connected to LCD board on the PC case panel for the user to facilitate reading the real time data of V, A, W, PH, KWH, HZ, F, WA, PF, and KWH.
